(19) United States
(12) Patent Application Publication
(10) Pub. No.: US 2004/0009704 A1
(43) Pub. Date: Jan. 15, 2004

(54) Shielding device for an electrical connector

(75) Inventors: Chih-Kuo Hsiao, Taipei City (TW); Chih-Wen Huang, Taipei City (TW)

Correspondence Address: BACON & THOMAS, PLLC, 625 SLATERS LANE, FOURTH FLOOR, ALEXANDRIA, VA, 22314

(73) Assignee: COMPAL ELECTRONICS, INC., Taipei City (TW)

(21) Appl. No.: 10/194,214

(22) Filed: Jul. 15, 2002

(51) Int. Cl. H01R 13/648

(52) U.S. Cl. 439/607

(57) ABSTRACT

A shielding device for shielding an electrical connector includes a shielding plate body formed integrally from a metal material. The shielding plate body includes a top plate portion for covering a top wall of the connector, and a front plate portion extending downwardly from a front edge of the top plate portion for covering a front side wall of the connector. The front plate portion has an opening to permit a connector mating portion on the front sidewall to extend therethrough. A rear plate portion extends downwardly from a rear edge of the top plate portion for covering a rear side wall of the connector. The shielding plate body further includes opposite lateral plate portions extending downwardly and respectively from opposite lateral edges of the top plate portion for covering opposite lateral side walls of the connector.

### BACKGROUND OF THE INVENTION

1. Field of the Invention

The present invention relates to a shielding device for shielding electromagnetic interference (EMI) in an electrical connector, more particularly to a shielding device with an excellent EMI shielding effect.

2. Description of the Related Art

A shielding device is in common use for shielding electromagnetic interference (EMI) attributed to conductive pins of an electrical connector. FIG. 1 shows a conventional EMI shielding device 92 for shielding an electrical connector 91 which has opposite front and rear side walls 911, 913, a top wall 912, opposite lateral side walls 914, 915, and a connector mating portion 910 projecting forwardly from the front side wall 911 and formed with a plurality of pin holes 916 for receiving conductive pins (not shown). The shielding device 92 includes a flat plate 921 for shielding the front side wall 911 and formed with an opening (not visible) to permit extension of the connector mating portion 911 therethrough, and a sleeve portion 922 extending around the opening and projecting forwardly from the flat plate 921 so as to be disposed around the connector mating portion 911. However, it is noted that the shielding device 92 only shields the front side wall 911 of the electrical connector 91. Since the top wall 912, the lateral side walls 914, 915, and the rear side wall 913 of the electrical connector 91 remain exposed, the shielding effect that can be achieved with the use of the shielding device 92 is not satisfactory.

### SUMMARY OF THE INVENTION

Therefore, the main object of the present invention is to provide an EMI shielding device which can achieve an excellent shielding effect and which can be produced at a relatively low manufacturing cost.

Accordingly, the EMI shielding device of the present invention is used for shielding an electrical connector which is to be mounted on a circuit board. The electrical connector has a bottom wall to be disposed on the circuit board, a top wall opposite to the bottom wall, front and rear side walls extending between the top and bottom walls, opposite first and second lateral side walls extending between the top and bottom walls and interconnecting the front and rear side walls, and a connector mating portion projecting forwardly from the front side wall. The EMI shielding device includes a shielding plate body formed integrally from a metal material. The shielding plate body includes a top plate portion, front and rear plate portions, and opposite first and second lateral plate portions. The top plate portion is adapted to be disposed on the top wall of the electrical connector for covering the top wall. The top plate portion has front and rear edges, and first and second lateral edges interconnecting the front and rear edges. The front plate portion extends downwardly from the front edge of the top plate portion, and is adapted to be disposed on the front side wall of the electrical connector for covering the front side wall. The front plate portion is formed with an opening that is adapted to permit extension of the connector mating portion therethrough. The rear plate portion extends downwardly from the rear edge of the top plate portion, and is adapted to be disposed on the rear side wall of the electrical connector for covering the rear sidewall. The first lateral plate portion extends downwardly from the first lateral edge of the top plate portion, and is adapted to be disposed on the first lateral side wall of the electrical connector for covering the first lateral side wall. The second lateral plate portion extends downwardly from the second lateral edge of the top plate portion, and is adapted to be disposed on the second lateral side wall of the electrical connector for covering the second lateral side wall.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded perspective view showing an electrical connector and a conventional EMI shielding device for shielding the electrical connector;

FIG. 2 is a plan view of a preferred embodiment of the EMI shielding device according to the present invention, where the EMI shielding device is shown to be in an unfolded state;

FIG. 3 is an exploded perspective view illustrating an electrical connector provided on a main circuit board;

FIG. 4 is a perspective view illustrating an electronic assembly incorporating the shielding device of the preferred embodiment and the electrical connector of FIG. 3; and

FIG. 5 is a lateral side view of the electronic assembly of FIG. 4.

### DETAILED DESCRIPTION OF THE PREFERRED EMBODIMENT

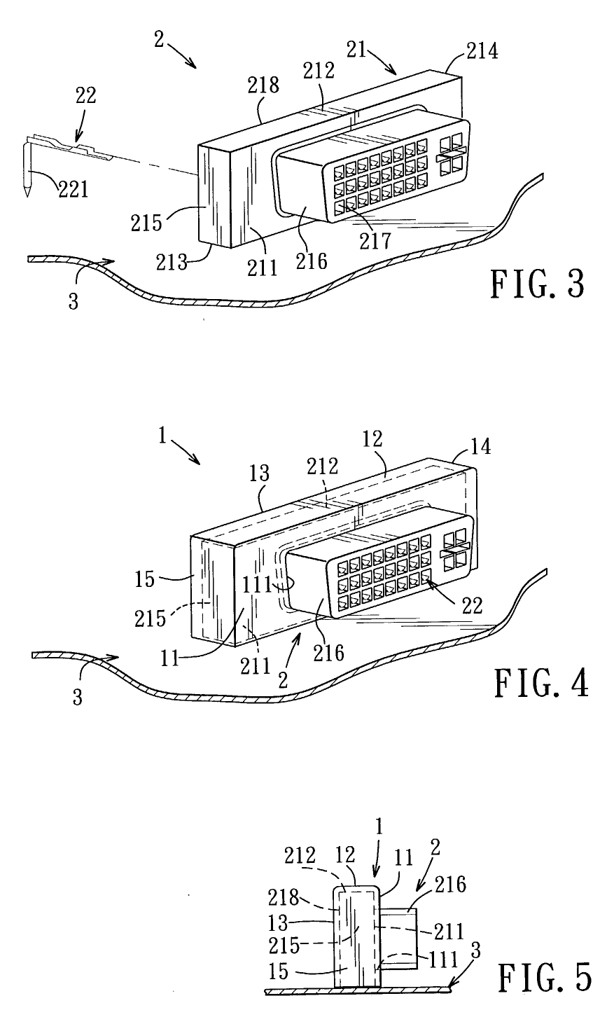

Referring to FIGS. 3 to 5, the preferred embodiment of the electromagnetic interference (EMI) shielding device 1 according to the present invention is adapted to be applied to an electrical connector 2 which is to be mounted on a circuit board 3. The electrical connector 2 has an electrically insulating housing 21 made of an electrically insulating material, such as plastic, and a plurality of conductive pins 22 received in the housing 21. The housing 21 has a bottom wall 213 to be disposed on the circuit board 3, a top wall 212 opposite to the bottom wall 213, parallel front and rear side walls 211, 218 extending between the top and bottom walls 212, 213, and parallel and opposite first and second lateral side walls 214, 215 extending between the top and bottom walls 212, 213 and interconnecting the front and rear side walls 211, 218. A connector mating portion 216 projects forwardly from the front side wall 211, and is formed with a plurality of pin grooves 217 therein for receiving the conductive pins 22. The conductive pins 22 have rear ends which are bent downwardly so as to be extended into a plurality of contact holes (not shown) formed in the circuit board 3 and so as to be soldered to the circuit board 3 in order to establish electrical connection between the electrical connector 2 and the circuit board 3.

The EMI shielding device 1 of the preferred embodiment is shown to include a foldable shielding plate body formed integrally from a metal, such as tin plated steel and phosphor bronze. The shielding plate body includes a top plate portion 12 adapted to cover the top wall 212 of the electrical connector 2, a front plate portion 11 extending downwardly from a front edge of the top plate portion 12 and adapted to cover the front side wall 211 of the electrical connector 2, a rear plate portion 13 extending downwardly from a rear edge of the top plate portion 12 and adapted to cover the rear side wall 218 of the electrical connector 2, a first lateral plate portion 14 extending downwardly from a first lateral edge of the top plate portion 12 and adapted to cover the first lateral side wall 214 of the electrical connector 2, and a second lateral plate portion 15 extending downwardly from a second lateral edge of the top plate portion 11 opposite to the first lateral edge and adapted to cover the second lateral side wall 215 of the electrical connector 22. The front plate portion 11 is formed with an opening 111 that is adapted to permit extension of the connector mating portion 216 therethrough.

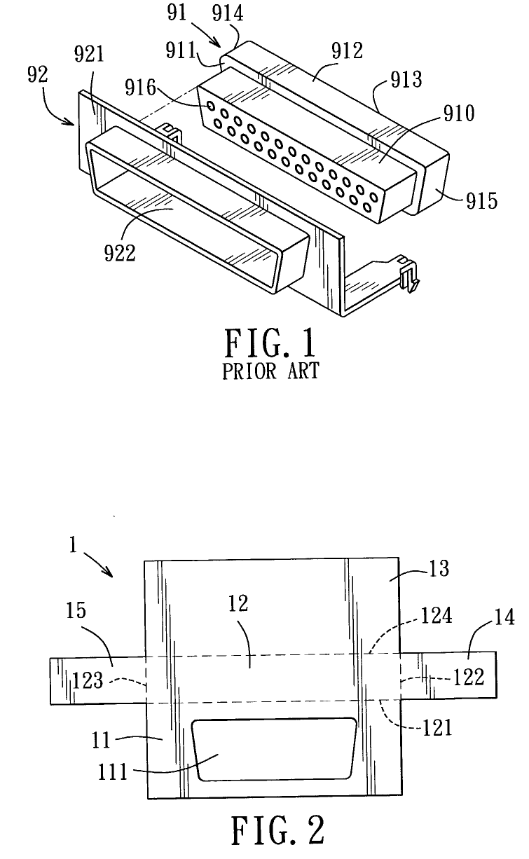

After manufacture, the shielding plate body 1 is initially formed into a flat sheet shown in FIG. 2, such as by punching. When the shielding device 1 is to be applied to the electrical connector 2, the front plate portion 12 is attached to the front side wall 211 of the connector 2 so as to permit extension of the connector mating portion 216 through the opening 111. The top plate portion 12 is then folded relative to the front plate portion 11 about a front folding line 121 so as to be disposed on the top wall 212 of the connector 2 for covering the same. The front folding line 121 thus defines the front edge of the top plate portion 12. Then, the first and second lateral plate portions 14, 15 are folded downwardly relative to the top plate portion 12 about parallel first and second lateral folding lines 122, 123 for covering the first and second lateral side walls 214, 215, respectively. The first and second lateral folding lines 122, 123 thus define the first and second lateral edges of the top plate portion 12. Finally, the rear plate portion 13 is folded downwardly relative to the top plate portion 12 about a rear folding line 124 parallel to the front folding line 121 for covering the rear side wall 218. The rear folding line 124 thus defines the rear edge of the top plate portion 12. In this manner, each of the front and rear side walls 211, 218, the first and second lateral side walls 214, 215, and the top wall 212 of the electrical connector 2 can be entirely covered by the shielding device 1 to effectively prevent electromagnetic interference between the electrical connector 2 and other electronic elements at the vicinity of the electrical connector 2.

In addition, since it is in the form of a flat metal sheet, the shielding device 1 is suitable for mass-production, and the manufacturing cost is accordingly lowered.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. An electromagnetic interference (EMI) shielding device for shielding an electrical connector which is to be mounted on a circuit board, the electrical connector having a bottom wall to be disposed on the circuit board, a top wall opposite to the bottom wall, front and rear side walls extending between the top and bottom walls, opposite first and second lateral side walls extending between the top and bottom walls and interconnecting the front and rear side walls, and a connector mating portion projecting forwardly from the front side wall, said EMI shielding device comprising:
a shielding plate body formed integrally from a metal material, said shielding plate body including:
a top plate portion adapted to be disposed on the top wall of the electrical connector for covering the top wall, said top plate portion having front and rear edges and opposite first and second lateral edges interconnecting the front and rear edges;
a front plate portion extending downwardly from said front edge of said top plate portion and adapted to be disposed on the front side wall of the electrical connector for covering the front side wall, said front plate portion being formed with an opening that is adapted to permit extension of the connector mating portion therethrough;
a rear plate portion extending downwardly from said rear edge of said top plate portion and adapted to be disposed on the rear side wall of the electrical connector for covering the rear side wall;
a first lateral plate portion extending downwardly from said first lateral edge of said top plate portion and adapted to be disposed on the first lateral side wall of the electrical connector for covering the first lateral side wall; and
a second lateral plate portion extending downwardly from said second lateral edge of said top plate portion and adapted to be disposed on the second lateral side wall of the electrical connector for covering the second lateral side wall.

2. An electronic assembly comprising:
an electrical connector adapted to be mounted on a circuit board, the electrical connector having a bottom wall adapted to be disposed on the circuit board, a top wall opposite to said bottom wall, front and rear side walls extending between said top and bottom walls, opposite first and second lateral side walls extending between said top and bottom walls and interconnecting said front and rear side walls, and a connector mating portion projecting forwardly from said front sidewall; and
an electromagnetic interference shielding device which includes a shielding plate body formed integrally from a metal material, said shielding plate body including:
a top plate portion disposed on said top wall of said electrical connector for covering said top wall, said top plate portion having front and rear edges and opposite first and second lateral edges interconnecting said front and rear edges;
a front plate portion extending downwardly from said front edge of said top plate portion and disposed on said front side wall of the electrical connector for covering said front side wall, said front plate portion being formed with an opening to permit extension of said connector mating portion therethrough;
a rear plate portion extending downwardly from said rear edge of said top plate portion and disposed on said rear side wall of said electrical connector for covering said rear side wall;
a first lateral plate portion extending downwardly from said first lateral edge of said top plate portion and disposed on said first lateral side wall of said electrical connector for covering said first lateral side wall; and
a second lateral plate portion extending downwardly from said second lateral edge of said top plate portion and disposed on said second lateral side wall of said electrical connector for covering said second lateral side wall.
